(19) United States
(12) Patent Application Publication
(10) Pub. No.: US 2013/0161173 A1
(43) Pub. Date: Jun. 27, 2013

(54) BUTTON ASSEMBLY WITH ONE ELASTIC MEMBER FOR MULTIPLE BUTTONS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: ZHOU CHEN, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/727,495

(22) Filed: Dec. 26, 2012

(30) Foreign Application Priority Data
Dec. 27, 2011 (CN) 201110443307.5

(51) Int. Cl. H01H 13/704

(52) U.S. Cl. 200/5 A

(57) ABSTRACT

A button assembly includes several buttons, a circuit board, and an elastic member sandwiched between the buttons and the circuit board. The circuit board includes several switches, each of which corresponds to one of the buttons and is mounted under the corresponding button. The elastic member includes a main body and several arms projecting from the main body, each of which is securely connected to a bottom of one of the buttons, and is used to support the one of the buttons. The elastic member is configured to apply a pushing force to the buttons, thereby enabling the buttons to return their original positions.

### BACKGROUND

1. Technical Field

The present disclosure relates to button assemblies, particularly, to a button assembly with one elastic member for multiple buttons.

2. Description of Related Art

Portable electronic devices with touch screen are common, such as cellular phones and tablet computers. Such portable electronic devices often include one or more physical buttons. Button assemblies used in such portable electronic devices need to have simple structure and can provide good tactile feedback. Although many button assemblies can satisfy basic requirements, it is still useful and desirable to provide a new button assembly.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric, exploded view of a button assembly according to one embodiment.

FIG. 2 is a planar assembled view of the button assembly of FIG. 1.

FIG. 3 is an isometric, assembled view of the button assembly of FIG. 1, with buttons omitted for clarity.

### DETAILED DESCRIPTION

Embodiments of the present disclosure will be described with reference to the accompanying drawings.

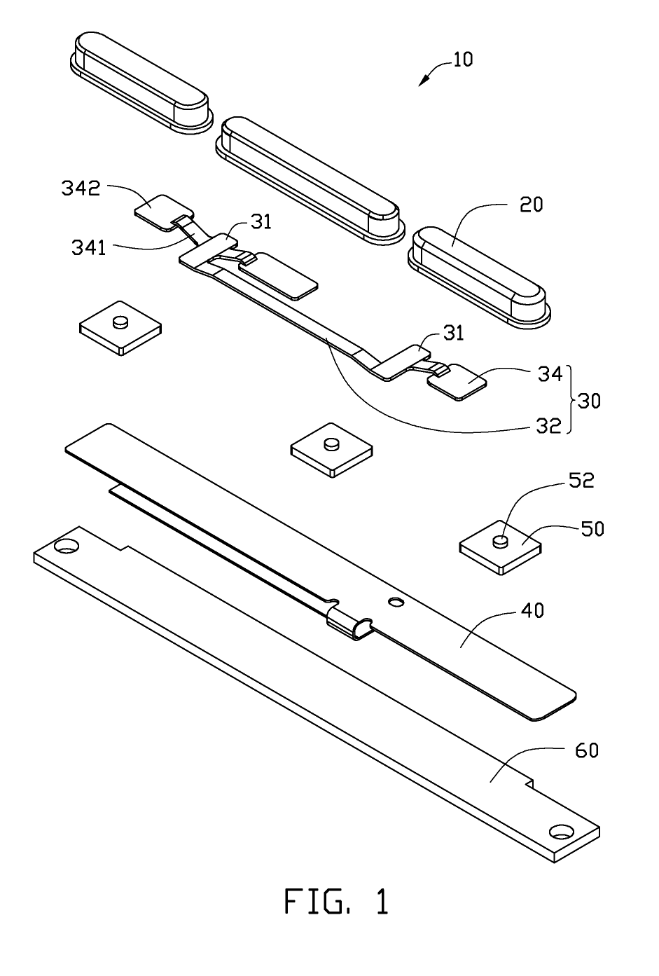

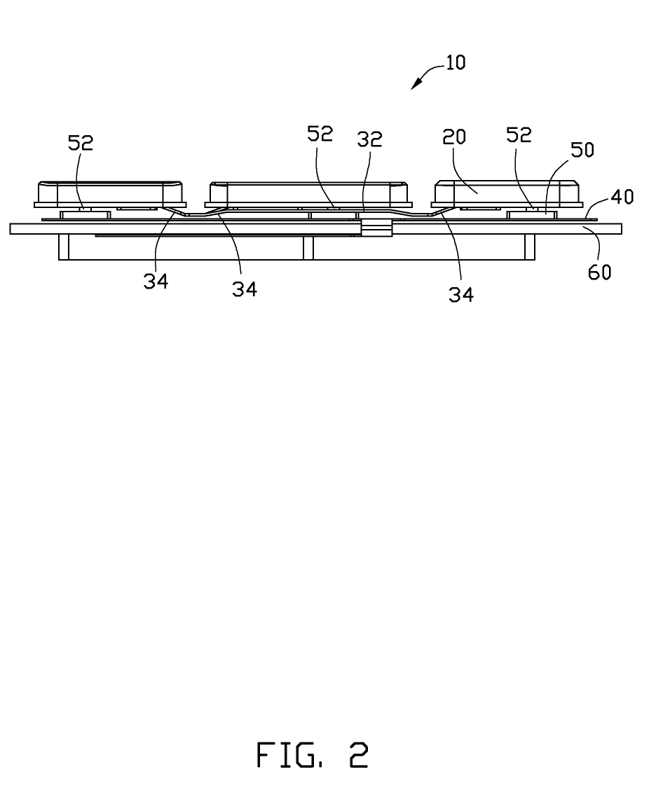

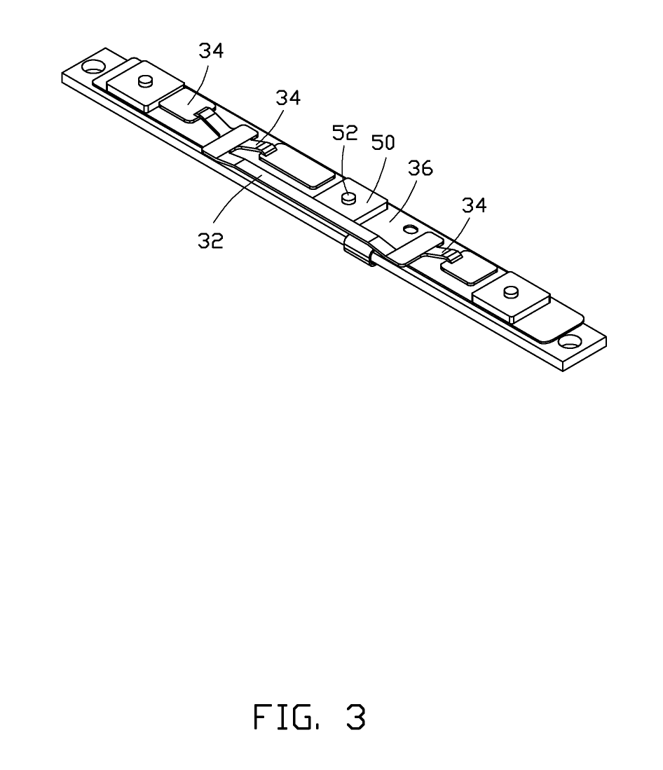

Referring to FIGS. 1-3, a button assembly 10 includes a number of buttons 20, an elastic member 30, and a circuit board 40 including a number of switches 50. In the embodiment, there are three buttons 20 and three switches 50.

The elastic member 30 is arranged between the buttons 20 and the circuit board 40. The elastic member 30 includes an elongated main body 32 and two angled portions 31 formed at opposite ends of the main body 32. The elastic member 30 further includes a number of elastic arms 34 projecting from the angled portions 31. In the embodiment, one elastic arm 34 projects from one of the angled portions 31, and two elastic arms 34 project from the other one of the angled portions 31 and extend in opposite directions. Each elastic arm 34 includes a tab 341 and a support pad 342 formed as the free end of the tab 341. The tab 341 projects from one of the angled portions 31 and inclines upwardly with respect to the one of the angled portions 31.

The main body 32 is securely coupled to the circuit board 40. Each support pad 342 is securely coupled to a bottom of the corresponding button 20, for example, by soldering or gluing. Each support pad 342 supports the corresponding button 20. Each button 20 is located above and spaced apart a distance from the corresponding switch 50. When depressed, each button 20 moves downward and can actuate the corresponding switch 50. When the depress has ceased, the depressed buttons 20 move back to their original positions by the rebounding, pushing force of the elastic arms 34.

In the embodiment, one switch 50 is arranged between the two angled portions 31, and the other two switches 50 are arranged at opposite sides of the elastic member 30. In the embodiment, the circuit board 40 is a flexible printed circuit board and mounted on a hard substrate 60.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A button assembly comprising:
a plurality of buttons;
a circuit board comprising a plurality of switches, each switch corresponding to one of the plurality of buttons and being mounted under the corresponding button; and
an elastic member sandwiched between the buttons and the circuit board, the elastic member comprising a main body and a plurality of elastic arms projecting from the main body, each of the plurality of elastic arms being securely connected to a bottom of a corresponding one of the plurality of buttons, and being configured to support the one of the plurality of buttons, the elastic member being configured to apply a pushing force to the buttons, thereby enabling the buttons to return original positions thereof.

2. The button assembly according to claim 1, wherein each the plurality of elastic arms is soldered to the corresponding one of the plurality of buttons.

3. The button assembly according to claim 1, wherein each the plurality of elastic arms is glued to the corresponding one of the plurality of buttons.

4. The button assembly according to claim 1, wherein each the plurality of elastic arms comprises a tab projecting from the main body and a support pad formed at one end of the tab, the support pad is securely connected to the bottom of one of the plurality of buttons.

5. The button assembly according to claim 1, wherein the main body is securely connected to the circuit board.

6. The button assembly according to claim 1, wherein the circuit board is a flexible printed circuit board and is mounted on a hard substrate.
